(19) United States
(12) Patent Application Publication
(10) Pub. No.: US 2025/0377257 A1
(43) Pub. Date: Dec. 11, 2025

(54) LIQUID SENSOR WITH LOW POWER STATE

(71) Applicant: Microchip Touch Solutions Limited, Wokingham (GB)

(72) Inventors: Marco Rohleder, Hamminkeln (DE); Colin Greaves, Manchester (GB)

(73) Assignee: Microchip Touch Solutions Limited, Wokingham (GB)

(21) Appl. No.: 18/931,451

(22) Filed: Oct. 30, 2024

Related U.S. Application Data
(60) Provisional application No. 63/658,485, filed on Jun. 11, 2024.

(51) Int. Cl. H02J 9/00; G01M 3/16

(52) U.S. Cl. CPC G01M 3/16; H02J 2310/52; H02J 2310/54

(57) ABSTRACT

A system includes a liquid sensor including first and second sensor electrodes, control circuitry connected to the first and second sensor electrodes, and a power source connected to the control circuitry. The control circuitry includes circuitry to alternately operate the system in a sleep state and an awake state, wherein the sleep state is a low power state relative to the awake state. The control circuitry includes circuitry to, during operation in the awake state, perform sensor measurements using the first and second sensor electrodes, transmit sensor data based on one or more sensor measurements, and transmit heartbeat signals indicating the system is operational.

### RELATED APPLICATION

This application claims priority to commonly owned U.S. Provisional Patent Application No. 63/658,485 filed Jun. 11, 2024, the entire contents of which are hereby incorporated by reference for all purposes.

### TECHNICAL FIELD

The present disclosure relates to systems and methods for a liquid sensor with a low-power state.

### BACKGROUND

Systems or sensors for detecting liquid leaks or otherwise detecting the presence of a liquid are useful in various applications. For example, many modern household appliances include systems for detecting liquid leaks or liquid presence. Conventional liquid detection systems include mechanical systems and electrical systems. Some mechanical systems use a mechanical float that rises to activate a float switch, which triggers a device shut-off or other anti-flood measure. Such devices have various drawbacks, for example including build-up of dirt or other contaminants that may affect operation, or physical breakdown or corrosion of plastics or other device materials over time.

Electrical liquid detection systems are typically built using analog electronics. Such systems typically consume relatively high power, wherein power reductions correspond with increased costs.

In addition, conventional liquid detection systems typically do not have a self-monitoring function, e.g., to inform the outside world of a malfunction or other problem with the system.

There is a need for low-power liquid detection systems, for example, with the ability to self-monitor and output notifications indicating an operational status of the system.

### SUMMARY

The present disclosure provides systems and methods for lower-power liquid detection, e.g., liquid detection with the ability to self-monitor and output notifications of the operational status of the system. Some examples provide liquid detection systems that are self-monitoring as well as operating at low power. Some examples provide liquid detection systems capable of monitoring their own function on a periodic/cyclic basis to prevent unnoticed liquid presence (e.g., leakage) due to a malfunction of the sensor system. Some examples provide liquid detection systems that operate at a very low power level (average over time), for example, to fulfill standby power regulations and/or to provide increased operating time for battery powered devices.

Some examples include a sensor system including a liquid sensor including first and second sensor electrodes, control circuitry including a processor and logic instructions (e.g., embodied in software or firmware) stored in memory and executable by the processor to control the liquid sensor, and a power source. In some examples, the control circuitry is embodied in a microcontroller connected to the liquid sensor and the power source. In some examples, instead of running continuously, the microcontroller only wakes up in intervals (awake state operation) to instruct the liquid sensor to take a measurement. In between awake state operation, the microcontroller operates in a sleep state and consumes almost no power (e.g., in the nanoampere range). In some examples, the cyclic wakeup is initiated by on-chip watchdog hardware of the microcontroller (e.g., as opposed to a separate watchdog timer), to thereby provide a failsafe system.

In some examples, the control circuitry may generate and transmit output signals during each awake state instance, regardless of whether liquid was detected during that awake state instance. The output signal may include, for example, a heartbeat signal (confirmation the control circuitry, e.g., processor, is still active), sensor measurement data from the liquid sensor or data derived therefrom, and/or sensor state data determined as function of sensor measurement data values. The sensor state may be encoded in “status byte,” and may indicate, for example, a liquid detection, a sensor fault, degradation of the sensor function, or other information. Thus, the microcontroller and/or liquid sensor may be self-monitoring.

In some examples, the sensor system operates with an average power over time, including multiple instances of sleep state operation and awake state operation, in a range of 1-100 μW. In some examples, the sensor system operates with an average power over time in a range of 1-10 microwatts (μW). In some examples, the sensor system operates with an average power over time of less than 2.0 μW.

One aspect provides a system including a liquid sensor including first and second sensor electrodes, control circuitry connected to the first and second sensor electrodes, and a power source connected to the control circuitry. The control circuitry includes circuitry to alternately operate the system in a sleep state and an awake state, wherein the sleep state is a low power state relative to the awake state. The control circuitry includes circuitry to, during operation in the awake state, perform sensor measurements using the first and second sensor electrodes, transmit sensor data based on one or more sensor measurements, and transmit heartbeat signals indicating the system is operational.

In some examples, the control circuitry to detect a liquid detection status based on at least one sensor measurement, and transmitting sensor data based on one or more sensor measurements comprises transmitting a liquid detection status signal indicating the determined liquid detection status.

In some examples, transmitting sensor data based on one or more sensor measurements comprises transmitting sensor measurement data generated by the one or more sensor measurements.

In some examples, the control circuitry includes circuitry to determine a liquid detection status based on multiple sensor measurements performed during multiple instance of awake state operation.

In some examples, the control circuitry includes circuitry to transmit respective heartbeat signals at a first frequency, and perform respective sensor measurements at a second frequency lower than the first frequency.

In some examples, the control circuitry includes circuitry to transmit respective heartbeat signals at a first frequency, and transmit respective sensor data at a second frequency lower than the first frequency.

In some examples, the control circuitry to operate the system over an operating period, including multiple instances of sleep state operation and multiple instances of awake state operation, with an average power in a range of 1-10 μW, or in particular examples, with an average power below 2.0 microwatts (μW).

In some examples, the control circuitry comprises a processor and logic instructions stored in non-transitory computer-readable media and executable by the processor.

In some examples, the processor and the logic instructions stored in the non-transitory computer-readable media are embodied in a microcontroller.

In some examples, the power source comprises a battery.

In some examples, the power source comprises a voltage regulator to modify a voltage provided to the processor.

In some examples, the control circuitry comprises a processor and a watchdog timer to wake the processor at a defined frequency, wherein the processor uses the watchdog timer to switch the system between the sleep state and the awake state at the defined frequency. In some examples, the watchdog timer is provided on-chip with the processor.

In some examples, the control circuitry to control the liquid sensor to reverse a polarity of the first and second sensor electrodes over time to reduce a corrosion of the first and second sensor electrodes.

One aspect provides a system including control circuitry to alternatingly operate the system in a sleep state and an awake state, wherein operating the system in the sleep state draws less current from a power source connected to the control circuitry than operating the system in the awake state, and during operation in the awake state: perform sensor measurements using a liquid sensor including sensor electrodes; transmit sensor data based on one or more sensor measurements; and transmit heartbeat signals indicating the system is operational.

In some examples, the control circuitry includes circuitry to determine a liquid detection status based on at least one sensor measurement, and transmitting sensor data comprises transmitting a signal indicating the determined liquid detection status.

In some examples, the control circuitry includes circuitry to determine a liquid detection status based on multiple sensor measurements taken determine a liquid detection status based on sensor measurements performed during multiple instances of awake state operation.

In some examples, transmitting sensor data comprises transmitting sensor measurement data generated by the sensor measurements.

In some examples, the control circuitry comprises a processor, and a watchdog timer to wake the processor at a defined frequency, wherein the processor uses the watchdog timer to switch the system between the sleep state and the awake state at the defined frequency.

One aspect provides a method, including alternatingly operating a liquid detection system in a sleep state and an awake state, wherein operating the system in the sleep state draws less current from a power source connected to the control circuitry than operating the system in the awake state, and during operation in the awake state: performing sensor measurements using a liquid sensor including sensor electrodes; transmitting sensor data based on one or more sensor measurements; and transmitting heartbeat signals indicating the system is operational.

In some examples, the method includes determining a liquid detection status based on at least one sensor measurement, and wherein transmitting sensor data comprises transmitting a signal indicating the determined liquid detection status.

In some examples, transmitting sensor data comprises transmitting sensor measurement data generated by the sensor measurements.

### BRIEF DESCRIPTION OF THE DRAWINGS

Example aspects of the present disclosure are described below in conjunction with the figures, in which:

FIG. 1 shows an example self-monitoring liquid detection system;

FIG. 2 shows an example self-monitoring liquid detection system, including one implementation of control circuitry for the system;

FIG. 3 shows an example self-monitoring liquid detection system, including a line power source and a voltage regulator; and

FIG. 4 is a flowchart of an example method of operating a self-monitoring liquid detection system, e.g., any of the example systems shown in FIGS. 1-3.

It should be understood that the reference number for any illustrated element that appears in multiple different figures has the same meaning across the multiple figures, and the mention or discussion herein of any illustrated element in the context of any particular figure also applies to each other figure, if any, in which that same illustrated element is shown.

### DETAILED DESCRIPTION

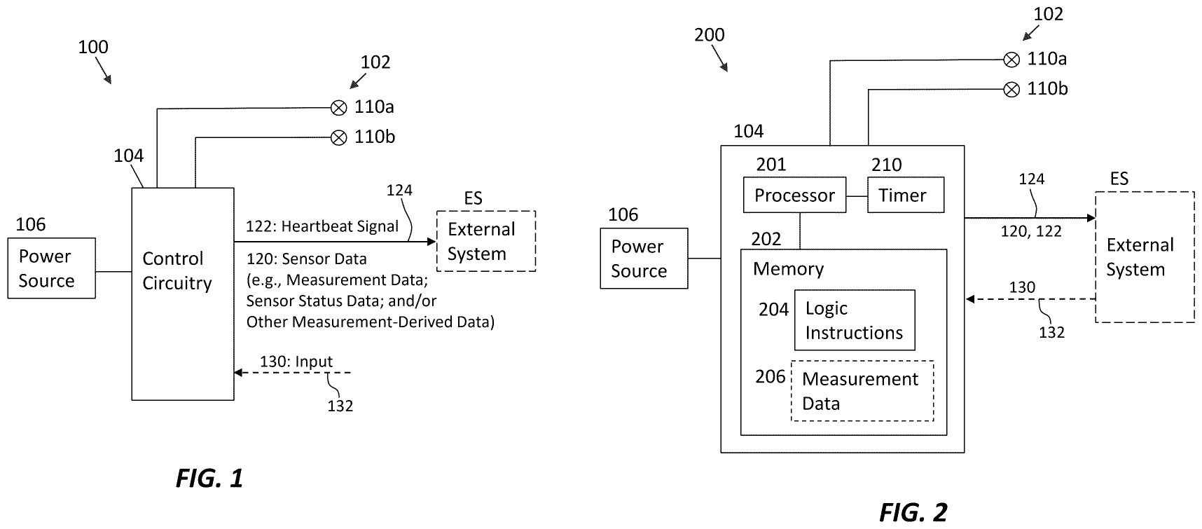

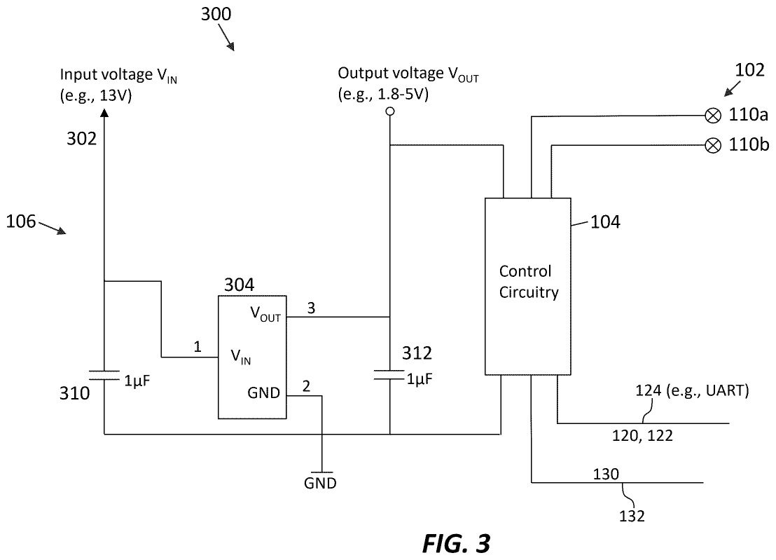

FIG. 1 shows an example self-monitoring liquid detection system 100. The example system 100 includes a liquid sensor 102, control circuitry 104, and a power source 106. The liquid sensor 102 includes a first sensor electrode 110a and a second sensor electrode 110b. The control circuitry 104 is connected to the first and second sensor electrodes 110a and 110b, and connected to the power source 106. The power source 106 may comprise, for example, a battery or line power (i.e., grid power), and may include a voltage regulator (e.g., as shown in FIG. 3 discussed below).

The control circuitry 104 may include circuitry to alternately operate the system 100 in a sleep state and an awake state, wherein the sleep state is a low power state relative to the awake state, i.e., consuming less power from the power source 106 in the sleep state than the awake state. In particular, control circuitry 104 may control the system 100 to alternative between instances of sleep state operation (“sleep state instances”) and instances of awake state operation (“awake state instances”). Thus, instead of running continuously, the control circuitry 104 only wakes up in intervals (awake state instances) to perform various functions (referred to herein as “awake state functions”), including taking sensor measurements. In between awake state operation, the control circuitry 104 operates in the sleep state in which the system 100 may consume very low power (e.g., in the range of 500-800 nanoamperes (nA) in one implementation). In some examples, the control circuitry 104 may switch to the awake state at a frequency in the range of 1 second to 10 minutes, for example waking every 8 seconds, every 20 seconds, every 60 seconds, or every 5 minutes to perform respective awake state functions. In other examples, the control circuitry 104 may switch to the awake state at a lower frequency, for example, in the range of 10 minutes to 1 day, for example waking every 10 minutes, 1 hour, 6 hours, or 24 hours to perform respective awake state functions.

The control circuitry 104 may include a processor and logic instructions stored in memory (e.g., embodied as firmware and/or software) and executable by the processor to perform at least the various functions of control circuitry 104 disclosed herein. In some examples, the processor and logic instructions stored in memory are embodied in a microcontroller. During operation in the awake state, the control circuitry 104 may perform various awake state functions, including, for example (a) performing sensor measurements using the first and second sensor electrodes 110a and 110b, (b) transmitting sensor data 120 based on one or more sensor measurements, and/or (c) transmitting heartbeat signals 122 indicating the system 100 is operational.

In some examples, the control circuitry 104 may include circuitry to perform conductive measurements to detect direct contact between sensor electrodes 110a and 110b and a liquid, or alternatively to perform capacitive measurements to detect the presence of a liquid proximate to sensor electrodes, with no electrical or physical connection required 110a and 110b (for example to avoid corrosion or other damage to sensor electrodes 110a and 110b in contact with the liquid to be detected). In examples in which the control circuitry 104 performs conductive measurements, the processor may reverse the polarity of the sensor electrodes 110a, 110b over time to reduce corrosion of the electrodes 110a, 110b.

In some examples, the awake state functions performed by the control circuitry 104 may also include analyzing sensor measurement data to determine “sensor state data” indicating at least one status of the liquid sensor 102 or system 100. Sensor state data may include, for example, data indicating the presence or absence of a liquid (referred to herein as a liquid detection status), data indicating a sensor fault associated with the liquid sensor 102, data indicating a degradation of the liquid sensor 102, etc. Thus, during a respective awake state instance, control circuitry 104 may analyze sensor measurement data to determine a liquid detection status, detect a sensor fault condition, detect a sensor degradation condition, or other information regarding the state of the liquid sensor 102 or system 100. In such examples, sensor data 120 transmitted by the control circuitry 104 may indicate various sensor state data (e.g., a liquid detection status, fault detection status, etc.). In some examples, sensor state data may be encoded in a designated “status byte.”

Control circuitry 104 may determine a liquid detection status based on one or multiple sensor measurements using the liquid sensor 102 (e.g., taking during one or multiple awake state instances) and using any suitable decision algorithm or rules, e.g., embodied in firmware or software. For example, control circuitry 104 may compare a sensor measurement value (e.g., a voltage or current measurement) or multiple sensor measurement values (e.g., an average or median of a series (e.g., sliding window) of voltage or current measurements) to a defined liquid detection threshold. As an example, control circuitry 104 may determine a change in sensor measurement values (over a series of sensor measurements) that exceeds a defined change threshold corresponding with detection of a liquid presence. Control circuitry 104 may use any other rules or algorithms for determining the liquid detection status.

In addition, in some examples, control circuitry 104 may determine a sensor fault condition based on one or multiple sensor measurements using the liquid sensor 102 and using any suitable decision algorithm or rules. For example, control circuitry 104 may compare a sensor measurement value (e.g., a voltage or current measurement) or multiple sensor measurement values (e.g., an average or median of a series (e.g., sliding window) of voltage to a defined sensor fault threshold (different than the liquid detection threshold).

In addition, in some examples, control circuitry 104 may similarly determine a sensor degradation condition based on a series of multiple sensor measurements and using any suitable decision algorithm or rules. For example, control circuitry 104 may determine a gradual change in sensor measurement values over time, e.g., by detecting a change exceeding a defined change threshold over a defined extended period of time.

In the examples discussed above, control circuitry 104 includes circuitry (e.g., executable firmware and/or software) to analyze sensor measurement data to determine various sensor state data, e.g., liquid detection, sensor fault detection, sensor degradation detection, etc. In other examples, analysis of sensor measurement data, e.g., including liquid detection, may be performed by an external system ES connected to the system 100. In such examples, the control circuitry 104 may transmit sensor measurement data to such external system ES for analysis (e.g., for liquid detection), without analysis of the sensor measurement data by the control circuitry 104 itself. In still other examples, both the control circuitry 104 of the sensor system 102 and an external system ES receiving sensor data 102 from the sensor system 102 may analyze respective sensor measurement data, e.g., to perform different types of data analysis and/or to provide a redundancy check. In other examples, the analysis of sensor measurement data is implemented by both the control circuitry 104 of the sensor system 102 and an external system ES working cooperatively, for example, wherein the control circuitry 104 of the sensor system 102 performs a part of the processing to analyze sensor measurement data and the external system ES performs another part of the processing to analyze the sensor measurement data.

Thus, based on the above, sensor data 120 as used herein may include (a) sensor measurement data generated from one or more sensor measurements (taken by control circuitry 104 using liquid sensor 102), (b) sensor state data indicating a state of the liquid sensor 102 of system 100 (for example, a liquid detection status, a sensor fault, a sensor degradation condition, or other information regarding the state of the liquid sensor 102 of system 100), and/or (c) any other data derived from sensor measurement data, for example, average data, outlying data (e.g., sensor measurement data above or below a respective threshold value), or data trends.

Further, references herein to control circuitry 104 transmitting sensor data 120 may refer to (a) the control circuitry 104 transmitting sensor measurement data (e.g., during each awake state instance or each N^{th} awake state instances), (b) the control circuitry 104 transmitting sensor state data, for example including liquid detection status data and/or other sensor state data (e.g., during each awake state instance or each N^{th} awake state instances, or only in response to a liquid detection, a sensor fault, or other defined event detected by control circuitry 104), (c) the control circuitry 104 transmitting other data derived from sensor measurement data (e.g., average data, outlying data, data trends, etc.), or (d) any combination of the above.

Heartbeat signals 122 may include signals indicating the system 100 is operational. For example, a heartbeat signal 122 may indicate the control circuitry 104 (in particular, a processor) remains powered and operational, as opposed to being unpowered or otherwise unable to generate a heartbeat signal 122.

By generating and transmitting heartbeat signals 122 (indicating the system 100 is operational) and/or certain sensor state data (e.g., indicating a sensor fault), the system 100 may monitor its own functionality on a periodic/cyclic basis, which may help avoid a liquid leak going undetected due to malfunction of the system 100. For example, a system connected to the system 100 may identify, based on heartbeat signals 122 and/or sensor data 120 (e.g., sensor status data) that the liquid sensor 102, control circuitry 104, or overall system 100 is non-operational or in a fault state, and take some corrective action in response, for example analyzing, charging, resetting, repairing, and/or replacing the liquid sensor 102 or control circuitry 104.

The control circuitry 104 may perform any one, some, or all awake state functions—e.g., including performing sensor measurements, (optionally) analyzing sensor measurement data to determine sensor state data, transmitting sensor data 120, and/or transmitting heartbeat signals 122—during the same awake state instance or during different awake state instances. For example, the control circuitry 104 may (a) perform a sensor measurement, (b) transmit sensor measurement data, and (c) transmit a heartbeat signal 122 (e.g., indicating the system 100 is operable) during each awake state instance.

As another example, the control circuitry 104 may (a) perform a sensor measurement, (b) determine sensor state data (e.g., including liquid detection, sensor fault detection, etc.), (c) transmit sensor measurement data, and (d) transmit a heartbeat signal 122 during each awake state instance. In addition, the control circuitry 104 may transmit determined sensor state data either (a) during each awake state instance (e.g., indicating “no liquid detected” or “liquid detected”) or (b) only in response to detecting a relevant sensor state (e.g., indicating detection of a liquid, a sensor fault, etc.), wherein the transmitted sensor state data indicates the type of detected sensor state.

As another example, the control circuitry 104 may transmit sensor state data without transmitting sensor measurement data. For example, the control circuitry 104 may (a) perform a sensor measurement, determine sensor state data (e.g., including liquid detection, sensor fault detection, etc.), and transmit a heartbeat signal 122 during each awake state instance, and (b) transmit sensor state data either (i) during each awake state instance (e.g., indicating “no liquid detected” or “liquid detected”) or (ii) only in response to detecting a relevant sensor state (e.g., liquid detection or sensor fault detection).

As another example, the control circuitry 104 may (a) transmit a heartbeat signal 122 during each awake state instance, and (b) perform sensor measurements, and transmit sensor measurement data during only a subset of awake state instances, e.g., during each N^{th} awake state instance (wherein N>1).

As another example, the control circuitry 104 may (a) transmit a heartbeat signal 122 during each awake state instance, and (b) perform sensor measurements, determine sensor state data (e.g., including liquid detection, sensor fault detection, etc.), and transmit sensor measurement data during each N^{th} awake state instance (wherein N>1). In addition, the control circuitry 104 may transmit sensor state data either (a) along with each transmission of sensor measurement data (e.g., indicating “no liquid detected” or “liquid detected”) or (b) only in response to detecting a relevant sensor state (e.g., indicating detection of a liquid, a sensor fault, etc.), wherein the transmitted sensor state data indicates the type of detected sensor state.

As yet another example, the control circuitry 104 may (a) transmit a heartbeat signal 122 (indicating the system 100 is operable), perform a sensor measurement, and determine sensor state data (e.g., including liquid detection, sensor fault detection, etc.) during each successive awake state instance, and (b) transmit sensor data 120 (e.g., sensor measurement data and/or sensor state data) during only a subset of awake state instances, e.g., during each N^{th} awake state instance.

As still another example, the control circuitry 104 may perform various functions at various different frequencies over a series of awake state instances. For example, the control circuitry 104 may (a) transmit a heartbeat signal 122 (indicating the system 100 is operable) during each successive awake state instance, (b) perform a sensor measurement and determine sensor state data (e.g., including liquid detection, sensor fault detection, etc.) at a first frequency (e.g., each 5th awake state instance), and (c) transmit sensor data 120 (e.g., sensor measurement data and/or sensor state data) at a second, lower frequency (e.g., each 20th awake state instance).

Based on the above, in some examples different awake state functions may be performed in different awake state instances, for example, where different awake state functions are performed at different frequencies. Accordingly, different awake state instances in a series of awake state instances may have different durations and consume different amounts of power, i.e., to perform the respective awake state functions in respective awake state instances. In some examples, awake state instances may draw a current of 1-2 mA and use an average of 3.3-10 milliwatts (mW) (for an operating voltage in the range of 3.3-5V), and respective sleep state instances may draw a current of 500-800 nA and use an average of 1.7-4.0 μW (for an operating voltage in the range of 3.3-5V).

As discussed above, the control circuitry 104 may utilize the sleep state (low power state) of the system 100 to reduce the power consumption of the system 100 over time. In some examples, the control circuitry 104 may cycle the system 100 between the awake state sleep state according to a duty cycle (i.e., percentage of time spent in the awake state over an extended time period) selected to reduce power consumption, while providing sensor data 120 (e.g., sensor measurement data and/or sensor state data) at a desired frequency, for example to detect and respond to a liquid detection (e.g., indicating a leak) with sufficient haste for the relevant leak monitoring scenario.

In some examples, the control circuitry 104 may implement a duty cycle sufficient to fulfill relevant standby power regulations and/or to provide increased operating time for a battery powered system 100. For example, respective awake state instances may use about 6 mW, respective sleep state instances may use about 2 μW, and the control circuitry 104 may implement a duty cycle below 1/100 (1%) to provide an average power below 60 μW over an extended time period (e.g., a period including over 1,000 active/sleep cycles). In some examples, the control circuitry 104 may implement a duty cycle below 1/1,000 (0.1%), e.g., to provide an average power below 8 μW over an extended time period. For example, the control circuitry 104 may implement an active state lasting 4 ms every 8 seconds (duty cycle=0.05%), with an active state power of 6 mW (1.8 mA*3.3V) and a sleep state power of 2 μW (average power=5 μW). In other examples, the control circuitry 104 may implement a duty cycle below 1/10,000 (0.01%). For example, the control circuitry 104 may implement an active state lasting 10 ms every 5 minutes (duty cycle=0.0033%), with an active state power of 6 mW (1.8 mA*3.3V) and a sleep state power of 2 μW (average power=2.5 μW). In other examples, the control circuitry 104 may implement a duty cycle below 1/100,000 (0.001%) or below 1/1,000,000 (0.0001%) over an extended time period.

The control circuitry 104 may use a timer to control the timing of switching from the sleep state to the awake state (and/or vice versa). In some examples, the control circuitry 104 may include a processor and a watchdog timer to wake the processor at a defined frequency (or otherwise at defined times), wherein the processor uses the watchdog timer to switch the system 100 between the sleep state and the awake state at the defined frequency. In some examples, the watchdog timer is provided on-chip with the processor. For example, in an implementation in which the control circuitry 104 is embodied in a microcontroller, the cyclic wakeup may be initiated by on-chip watchdog hardware of the microcontroller, to thereby avoid reliance on a separate watchdog timer. In some examples, the on-chip watchdog timer may use an on-chip RC oscillator that runs continuously, e.g., as opposed to using a timer running off a main RC oscillator, which uses more current to switch states. The on-chip watchdog may provide an inherent failsafe, e.g., in event of a device crash caused by EMI interference.

Output signals transmitted by the system 100, e.g., including heartbeat signals 122 and sensor data 120, may be transmitted via an output interface 124 including any suitable wired and/or wireless communication link or links. In some examples, the output interface 124 may comprise a Universal Asynchronous Receiver-Transmitter (UART) interface, an I2C interface, an I3C interface, a pulse width modulation (PWM) interface, a Serial Peripheral Interface (SPI) interface, or a Single Edge Nibble Transmission (SENT or SENT-B) based interface.

In some examples, the system 100 (in particular, control circuitry 104) may optionally be configured to receive input 130 via an input interface 132, e.g., from the external system ES connected to the output interface 124, or from another external system or device. The input interface 132 may comprise distinct communication link(s) from the output interface 124 (e.g., using separate pins), or alternatively may share the same communication link(s) with output interface 124 (e.g., using a common pin).

Input 130 may include system setting data (e.g., used by control circuitry 104 to set and/or adjust respective system settings), e.g., (a) input specifying a type of sensor measurement implemented by control circuitry 104 (e.g., capacitive measurement or conductive measurement), (b) input specifying frequencies or other timing for respective awake state functions (e.g., sensor measurements, determination of respective sensor state data (e.g., liquid detection, fault detection, etc.), and/or transmission of respective types of sensor data 120, (c) input specifying algorithms, rules, or threshold values for determining respective types of sensor state data (e.g., liquid detection, fault detection, etc.), or (d) any other settings associated with the operation of system 100.

FIG. 2 shows an example self-monitoring liquid detection system 200 including liquid sensor 102, control circuitry 104, and power source 106. System 200 represents an example implementation of system 100 discussed above, wherein the control circuitry 104 in this example includes a processor 201, memory 202 storing logic instructions 204 and (optionally) measurement data 206, and a timer 210 (e.g., a watchdog timer). In some examples, control circuitry 104 of the example system 200 is embodied in a microcontroller. In other examples, the various components of control circuitry 104 may be embodied in discrete IC dies or packages.

As discussed above, the power source 106 may comprise a battery or line power (i.e., grid power), and in some examples may include a voltage regulator.

FIG. 3 shows an example self-monitoring liquid detection system 300, e.g., similar to example system 100 or 200 discussed above, wherein the power source 106 includes a line power source 302 and a voltage regulator 304 to regulate (e.g., step down and filter) voltage to the control circuitry 104. In some examples the control circuitry 104 may be embodied in a microcontroller. As shown, the power source 106 may include (a) a first capacitor 310 to block high frequency noise, e.g., to protect the input of the voltage regulator 304, and (b) a second capacitor 312 to block high frequency noise, e.g., to protect control circuitry 104.

In an alternative implementation, the power source 106 of the example system 300 (including line power source 302 and voltage regulator 304) may be replaced by a battery.

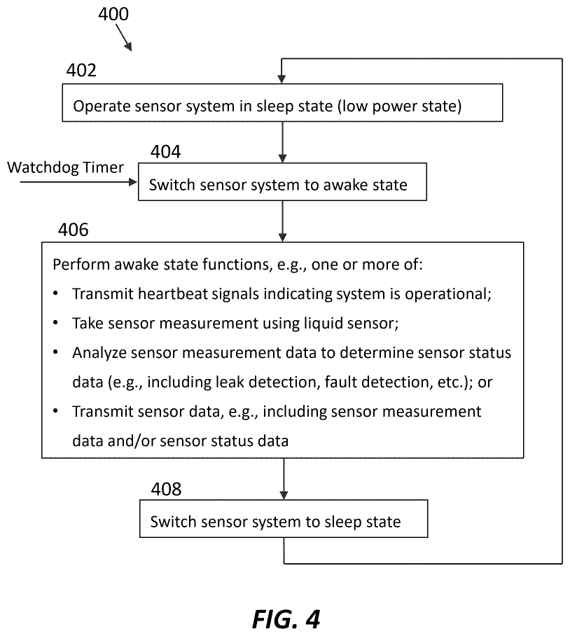

FIG. 4 is a flowchart of an example method 400 of operating a self-monitoring liquid detection system, e.g., any of the example systems 100, 200, or 300 discussed above. At 402, the control circuitry 104 operates the system in the sleep state, i.e., a low power state. At 404, the control circuitry 104 switches the system from the sleep state to the awake state, e.g., in response to a watchdog timer signal. At 406, the control circuitry 104 may perform one or more awake state functions, for example transmitting a heartbeat signal 122 indicating the system is operational, taking a sensor measurement using the liquid sensor 102, analyzing sensor measurement data to determine sensor status data (e.g., including liquid detection, fault detection, etc.), and/or transmitting sensor data 120, e.g., including sensor measurement data and/or sensor status data.

As discussed above, control circuitry 104 may perform different awake state functions at different frequencies, for example, during each awake state instance or during each N^{th} awake state instance (wherein N may differ for different awake state functions), or in some implementations, only in response to a triggering event (e.g., in some examples, control circuitry 104 may send a liquid detection signal only upon detecting a liquid)

At 408, the control circuitry 104 switches the system from awake state back to the sleep state to the awake state, e.g., upon completion of the awake state functions.

Although example embodiments have been described above, other variations and embodiments may be made from this disclosure without departing from the spirit and scope of these embodiments.

1. A system, comprising:
a liquid sensor including first and second sensor electrodes;
control circuitry connected to the first and second sensor electrodes;
a power source connected to the control circuitry; and
the control circuitry to:
alternately operate the system in a sleep state and an awake state, wherein the sleep state is a low power state relative to the awake state;
during operation in the awake state:
perform sensor measurements using the first and second sensor electrodes;
transmit sensor data based on one or more sensor measurements; and
transmit heartbeat signals indicating the system is operational.

2. The system of claim 1, wherein:
the control circuitry to determine a liquid detection status based on at least one sensor measurement; and
transmitting sensor data based on one or more sensor measurements comprises transmitting a liquid detection status signal indicating the determined liquid detection status.

3. The system of claim 1, wherein transmitting sensor data based on one or more sensor measurements comprises transmitting sensor measurement data generated by the one or more sensor measurements.

4. The system of claim 1, wherein the control circuitry includes circuitry to determine a liquid detection status based on multiple sensor measurements performed during multiple instance of awake state operation.

5. The system of claim 1, wherein the control circuitry includes circuitry to:
transmit respective heartbeat signals at a first frequency; and
perform respective sensor measurements at a second frequency lower than the first frequency.

6. The system of claim 1, wherein the control circuitry includes circuitry to:
transmit respective heartbeat signals at a first frequency; and
transmit respective sensor data at a second frequency lower than the first frequency.

7. The system of claim 1, wherein the control circuitry to operate the system over an operating period, including multiple instances of sleep state operation and multiple instances of awake state operation, with an average power in a range of 1-10 μW.

8. The system of claim 1, wherein the control circuitry to operate the system over an operating period, including multiple instances of sleep state operation and multiple instances of awake state operation, with an average power below 2.0 μW.

9. The system of claim 1, wherein the control circuitry comprises:
a processor; and
logic instructions stored in non-transitory computer-readable media and executable by the processor.

10. The system of claim 9, wherein the processor and the logic instructions stored in the non-transitory computer-readable media are embodied in a microcontroller.

11. The system of claim 9, wherein the power source comprises a voltage regulator to modify a voltage provided to the processor.

12. The system of claim 1, wherein the power source comprises a battery.

13. The system of claim 1, wherein the control circuitry comprises:
a processor; and
a watchdog timer to wake the processor at a defined frequency; and
wherein the processor uses the watchdog timer to switch the system between the sleep state and the awake state at the defined frequency.

14. The system of claim 13, wherein the watchdog timer is provided on-chip with the processor.

15. The system of claim 13, wherein the control circuitry to control the liquid sensor to reverse a polarity of the first and second sensor electrodes over time to reduce a corrosion of the first and second sensor electrodes.

16. A system, comprising:
control circuitry to:
alternately operate the system in a sleep state and an awake state;
wherein operating the system in the sleep state draws less current from a power source connected to the control circuitry than operating the system in the awake state; and
during operation in the awake state:
perform sensor measurements using a liquid sensor including sensor electrodes;
transmit sensor data based on one or more sensor measurements; and
transmit heartbeat signals indicating the system is operational.

17. The system of claim 16, wherein:
the control circuitry includes circuitry to determine a liquid detection status based on at least one sensor measurement; and
transmitting sensor data comprises transmitting a signal indicating the determined liquid detection status.

18. The system of claim 16, wherein the control circuitry includes circuitry to determine a liquid detection status based on multiple sensor measurements taken determine a liquid detection status based on sensor measurements performed during multiple instances of awake state operation.

19. The system of claim 16, wherein transmitting sensor data comprises transmitting sensor measurement data generated by the sensor measurements.

20. The system of claim 16, wherein the control circuitry comprises:
a processor; and
a watchdog timer to wake the processor at a defined frequency; and
wherein the processor uses the watchdog timer to switch the system between the sleep state and the awake state at the defined frequency.

21. A method, comprising:
controlling, by control circuitry, a liquid detection system to alternately operate in a sleep state and an awake state;
wherein operating the system in the sleep state draws less current from a power source connected to the control circuitry than operating the system in the awake state; and
during operation in the awake state:
performing sensor measurements using a liquid sensor including sensor electrodes;
transmitting sensor data based on one or more sensor measurements; and
transmitting heartbeat signals indicating the system is operational.

22. The method of claim 21, comprising:
determining a liquid detection status based on at least one sensor measurement; and
wherein transmitting sensor data comprises transmitting a signal indicating the determined liquid detection status.

23. The method of claim 21, wherein transmitting sensor data comprises transmitting sensor measurement data generated by the sensor measurements.
